(19) United States
(12) Patent Application Publication
(10) Pub. No.: US 2008/0111672 A1
(43) Pub. Date: May 15, 2008

(54) Entrapment detecting apparatus, sensor insertion apparatus and sensor insertion method

(75) Inventors: Masayoshi Takeuchi, Kariya-shi (JP); Takehiko Sugiura, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/979,625

(22) Filed: Nov. 6, 2007

(30) Foreign Application Priority Data
Nov. 10, 2006 (JP) 2006-305924

(51) Int. Cl. B60Q 1/00

(52) U.S. Cl. 340/438

(57) ABSTRACT

An entrapment detecting apparatus for detecting an entrapment of an object between a moving member and its paired member includes a pressure sensor serving for detecting the entrapment, and a protector provided at a portion of one of the moving member and the paired member for being opposed to the other of the moving member and the paired member, the protector being formed of an elastic material, the protector being provided therein with an insertion hole in which the pressure sensor is held by elasticity of the elastic member, the insertion hole having a diameter equal to or smaller than that of the pressure sensor, the holding of the pressure sensor in the insertion hole being established in such a manner that the insertion hole is expanded at room temperature to receive the pressure sensor and is restored upon completion of the reception of the pressure sensor.

### CROSS REFERENCE TO RELATED APPLICATIONS

This application is based on and claims priority under 35 U.S.C §119 with respect to Japanese Patent Application 2006-305924, filed on Nov. 10, 2006, the entire content of which is incorporated herein by reference.

### FIELD OF THE INVENTION

This invention generally relates to an entrapment detecting apparatus for detecting an entrapment of an object between a moving member and its paired member, a sensor insertion apparatus for inserting a sensor into a protector provided on the entrapment detecting apparatus and a method for inserting the sensor.

### BACKGROUND

As an entrapment detecting apparatus for detecting an entrapment of an object, for example, a contact detecting apparatus disclosed in JP2006-144315A is known. The contact detecting apparatus includes an elastic portion which is holding a sensor and formed by a two layer structure of a first elastic portion and a second elastic portion each having different elastic coefficients. The first elastic portion is deformed by a small load and the second elastic portion is harder than the first elastic portion. This allows detection of an entrapment of an object even when a dynamic load is applied to the first elastic portion that has already been crushed by a static load. This is because a strain applied to the sensor is changed by deformation of the second elastic portion.

JP11-72395A discloses a technique to insert a sensor in a protector. According to the technique, the protector made of a mixed material of EPDM rubber and polyethylene is heated, and a portion of the protector, where the sensor is to be inserted is filled with pressurized hot air. A sensor is inserted into the insertion portion expanded by the pressurized hot air, and then the protector is re-heated and shrunk so that the sensor is intimately buried in the protector.

The apparatus disclosed in the JP2006-144315A may have deformation of the elastic portion due to vibrations of a door as the elastic portion, which holds the sensor, is soft, thus leading to misdetection of the sensor. In addition, since the elastic portion holding the sensor is constituted by the two layers, the structure of the apparatus is complex.

The technique disclosed in the JP11-72395A may involve misdetection of the sensor after being installed on a vehicle because the sensor is heated by the heated protector. In addition, an operation of inserting the sensor is complex because the protector is heated and filled with the pressurized hot air to expand the insertion portion and then the protector is re-heated after the sensor is inserted.

A need thus exists for an entrapment detecting apparatus, a sensor insertion apparatus and a sensor insertion method, which is not susceptible to the drawback mentioned above.

### SUMMARY OF THE INVENTION

In light of the foregoing, the present invention provides an entrapment detecting apparatus for detecting an entrapment of an object between a slide door and a door frame, which includes a pressure sensor serving for detecting the entrapment, and a protector provided at a portion of one of the slide door and the door frame for being opposed to the other of the slide door and the door frame, the protector being formed of an elastic material, the protector being provided therein with an insertion hole in which the pressure sensor is held by elasticity of the elastic member, the insertion hole having a diameter equal to or smaller than that of the pressure sensor, the holding of the pressure sensor in the insertion hole being established in such a manner that the insertion hole is expanded at room temperature to receive the pressure sensor and is restored upon completion of the reception of the pressure sensor.

According to another aspect of the present invention, an insertion apparatus for inserting the bar-like pressure sensor into the protector formed of the elastic material and provided with the insertion hole for inserting the pressure sensor includes an air compressor for supplying fluid from a first end of the insertion hole and an insertion device for inserting the pressure sensor from a second end of the insertion hole.

According to a further aspect, the present invention provides a method for inserting a pressure sensor into the protector constituting the entrapment detecting apparatus, wherein the protector is formed of the elastic material and provided with an insertion hole for inserting a bar-like pressure sensor, the diameter of the insertion hole is equal to or smaller than that of the bar-like pressure sensor, and the pressure sensor is inserted into the insertion hole while fluid is supplied from the first end of the insertion hole toward the second end thereof to expand the insertion hole by a fluid pressure caused by blocking a flow of the fluid with the pressure sensor.

### BRIEF DESCRIPTION OF THE DRAWINGS

FIG. 1 is a diagram of a slide door adapted to a vehicle, which is equipped with an entrapment detecting apparatus according to the embodiment of the present invention.

FIG. 2 is a diagram of a slide door provided with an entrapment detecting apparatus.

FIG. 3A is a cross-sectional view of a protector.

FIG. 3B is a graph showing the correlation between a generated voltage and a frequency of the generated voltage when different diameters of an insertion hole for inserting a sensor are applied.

FIG. 4 is a diagram of an example of a shape of a pressure sensor.

FIG. 5 is a diagram showing a structure of an insertion apparatus.

FIG. 6A is a diagram of a plug.

FIG. 6B is a diagram of a funnel.

FIG. 6C is a diagram of a cone.

FIG. 7 is a flow chart showing a procedure for inserting a pressure sensor into a protector.

FIG. 8 is a diagram showing how a pressure sensor is inserted into a protector.

FIG. 9 is a diagram showing a circuit structure of an entrapment detecting apparatus.

FIG. 10A is a diagram of a hatchback door adapted to a vehicle.

FIG. 10B is a diagram showing an example of an arrangement of pressure sensors provided on a hatchback door of a vehicle, seen from an inside of the vehicle.

### DETAILED DESCRIPTION

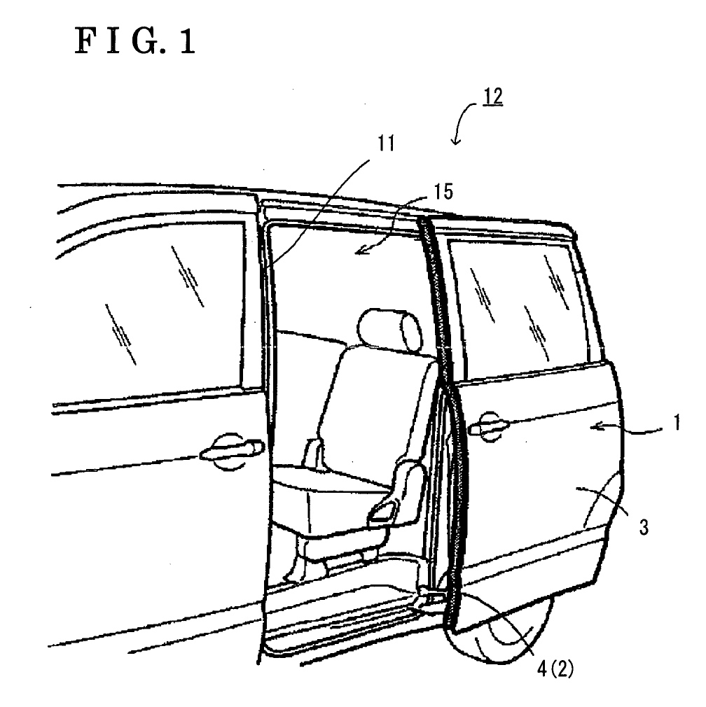

An entrapment detecting apparatus 4 according to an embodiment will be described below with reference to the attached drawings hereinafter. The embodiment is described in the context of the entrapment detecting apparatus 4 applied to a slide door 1 (serving as a moving member) adapted to a vehicle is described. FIG. 1 is a diagram illustrating the slide door 1 adapted to the vehicle, which is equipped with the entrapment detecting apparatus 4.

As illustrated in FIG. 1, a lateral side of a vehicle 12 is formed with an opening 15 for allowing a passenger to ingress and egress the vehicle, and for loading and unloading an object. The opening 15 is provided with a slide door 1 serving as a door adapted to the vehicle. The slide door 1 is provided with guide rails in an upper portion and a lower portion thereof respectively so as to be guided for sliding in a horizontal direction thereof. The slide door 1 covers the opening 15 closing towards a door frame 11 (serving as a paired member in relation to the moving member and as a frame).

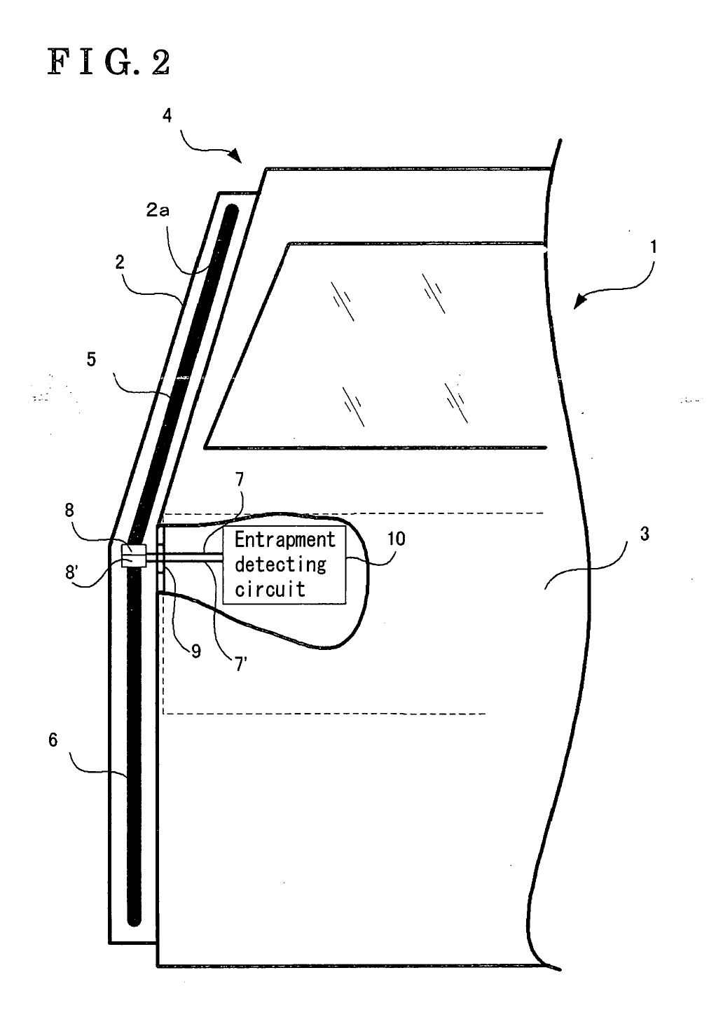

The entrapment detecting apparatus 4 is arranged on the slide door 1, at a portion opposed to the door frame 11. When the passenger or the object is entrapped in the opening 15 between the slide door 1 serving as a moving member and the door frame 1 serving as the paired member while the slide door 1 is being closed, and thereby comes in contact with either of the slide door 1 or the door frame 1, such a state is referred to as an occurrence of an entrapment. When the entrapment has occurred, the slide door 1 needs to stop its movement or perform a reverse operation. For this purpose, the slide door 1 is provided with the entrapment detecting apparatus 4 for detecting the occurrence of the entrapment of the object. FIG. 2 illustrates a structure of the slide door 1 provided with the entrapment detecting apparatus 4.

As shown in FIG. 2, the entrapment detecting apparatus 4 includes a protector 2 attached to the slide door 1, two pressure sensors 5, 6 inserted into the protector 2 respectively and an entrapment detecting circuit 10 arranged on a door panel 3.

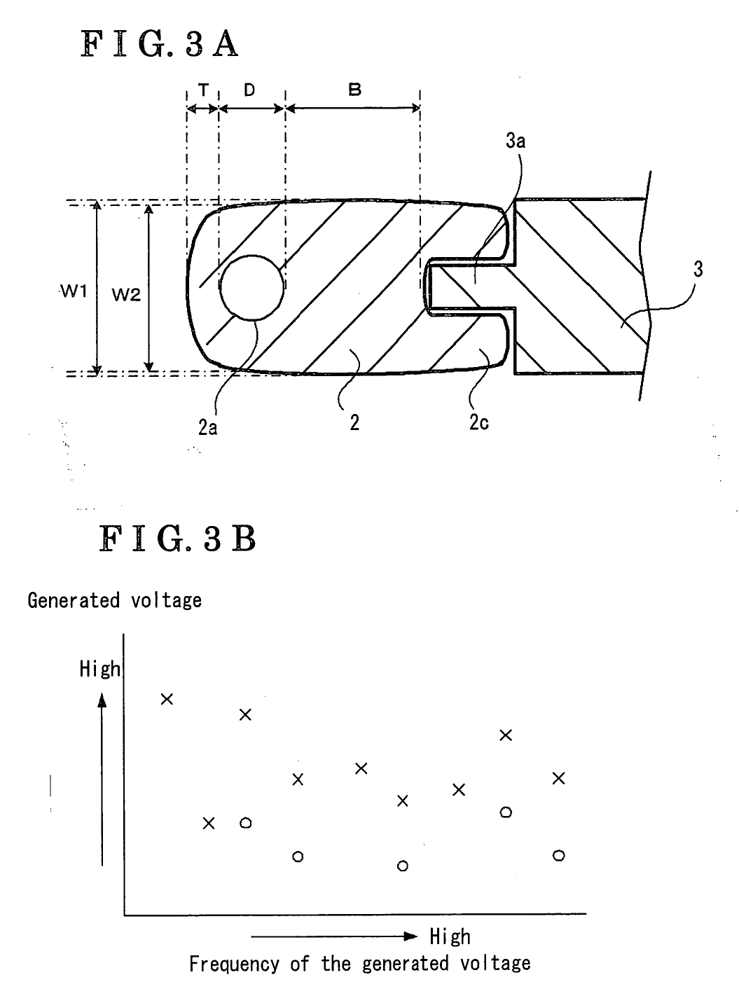

The protector 2 is attached to the slide door 1, the portion opposed to the door frame 11, so as to extend in a longitudinal direction of the slide door 11. The protector 2 is formed of the elastic material. FIG. 3A is a cross-sectional view illustrating the protector 2. As shown in FIG. 3A, the protector 2 includes an insertion hole 2a formed at an end portion thereof for inserting the pressure sensors 5, 6, and includes an attaching portion 2c at a base portion thereof. The attaching portion 2c is attached to the door panel 3 while sandwiching a supporting portion 3a provided on the door panel 3.

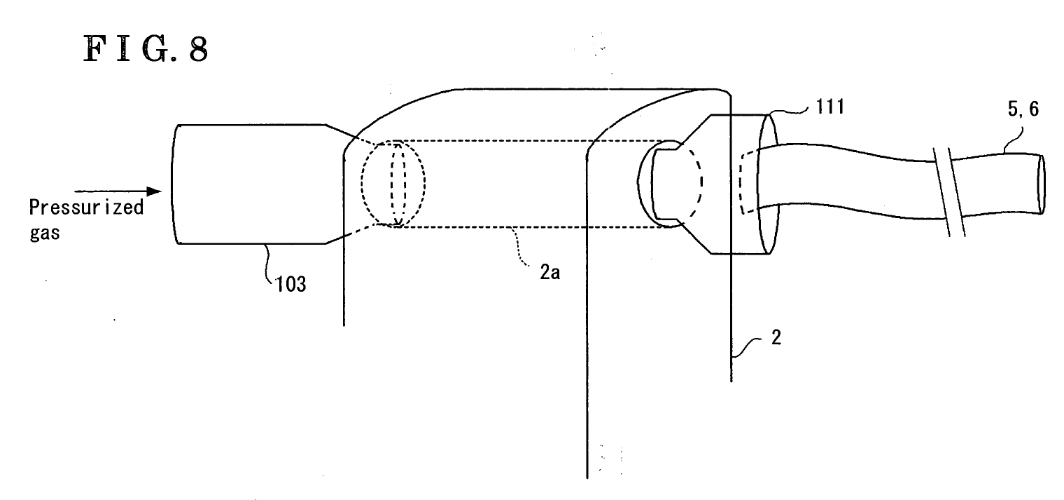

The insertion hole 2a is formed to have a diameter that is smaller than a diameter of the pressure sensors 5, 6 respectively. Consequently, in order to insert the pressure sensors 5, 6 into the insertion hole 2a, the insertion hole 2a needs to be expanded, for example, by filling air inside thereof as described later referring to FIG. 8. The protector 2, therefore, is made of a flexible material that allows expansion of the diameter thereof when the air is filled inside thereof. In addition, the material of the protector 2 is capable of holding the pressure sensors 5, 6 in an inserted state into the hole 2a. According to the embodiment of the present invention, for example, the protector 2 is made of foam rubber.

FIG. 3B shows the correlation between voltage generated by vibration and frequency of the vibration when different diameters of the insertion hole 2a are applied. In this experiment, the entrapment detecting apparatus 4 is vibrated by a vibration testing machine at a low frequency by changing the diameters of the insertion hole 2a to measure the generated voltage. In the figure, values of generated voltage when the diameter of the insertion hole 2a is equal to or smaller than those of the pressure sensors 5, 6 are marked with ◯, and values of generated voltages when the diameter of the insertion hole 2a is larger than those of the pressure sensors 5, 6 are marked with X. At the low frequency band, when the diameter of the insertion hole 2a is equal to or smaller than the diameters of the pressure sensors 5, 6, the generated voltage is too small to occur.

As shown in FIG. 3B, the generated voltage at low frequency is lowered when the diameter of the insertion hole 2a is equal to or smaller than the diameters of the pressure sensors 5, 6. This is because the protector 2 is made of the foam rubber, which ensures a good insertability of the pressure sensors 5, 6 into the protector 2. Also contraction characteristics of the foam rubber allow the pressure sensors 5, 6 to be fixed (held firmly) inside the protector 2. The foam rubber having a foaming density of 0.1 grams to 1 gram per cubic millimeter is preferably used as the foam rubber forming the protector 2.

Consequently, by setting the diameter of the insertion hole 2a equal to or smaller than those of the pressure sensors 5, 6, the pressure sensors 5, 6 are controlled so as not to move inside the insertion hole 2a by the vibration of the protector 2. In addition, the pressure sensors 5, 6 are fixed firmly inside the insertion hole 2a and controlled not move due to external vibration. As a result, voltage generated by vibration noise is reduced.

It is desirable that length T of a foreside of the insertion hole 2a be relatively short and length B of a portion from the insertion hole 2a to the base portion be sufficiently long. This allows pressure to be first applied to the pressure sensors 5, 6 when the object comes contact with the protector 2 and that allows the object to remain free from an intense pressure for a certain period of time by letting the entire protector 2 being deformed. A preferable ratio of length of each portion is substantially 3D>T>D/2, 10D>B>D (preferably B>3D), B>2·T (preferably B>3·T). The protector 2 preferably includes a substantially uniform width. However, width W2 of the protector 2, around the insertion hole 2a, may be smaller than width W1 of another portion (a central portion) of the protector 2.

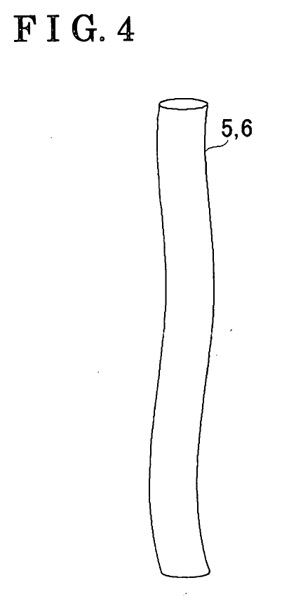

As shown in FIG. 4, the pressure sensors 5, 6 are sensors each formed into a rod shape and having, for example, a same length. The shape of the pressure sensors 5, 6 is not limited to the rod shape and may have a wire or a cable-like outer profile. The pressure sensors 5, 6 are inserted into the insertion hole 2a provided on the protector 2 and are arranged linearly inside thereof (arranged continuously in a longitudinal direction thereof). When the object comes in contact with the pressure sensors 5, 6, the pressure sensors 5, 6 output a pressure sensitive output signal corresponding to the applied pressure. The diameters of the pressure sensors 5, 6 are equal to or slightly smaller than diameter D of the insertion hole 2a provided on the protector 2 before the pressure sensors 5, 6 are inserted thereinto.

As shown in FIG. 2, the pressure sensors 5, 6 are inserted into the insertion hole 2a provided on the protector 2 and the protector is attached to a side of the door panel 3 so that the pressure sensors 5, 6 are arranged extending along the side of the door panel 3.

The pressure sensors 5, 6 may include any structures and principles for detecting pressure as long as being formed in the rod shape, or the like, and are capable of detecting pressure caused by the entrapment, however, application of a piezoelectric sensor is preferable. This is because the piezoelectric sensor, which generates voltage when distorted, is more likely to be distorted when the protector 2 is soft and thereby provides better detectability of the entrapment. Further, the piezoelectric sensor does not perform error detection even when the piezoelectric sensor is closely contacted with the protector 2.

In order to insert the pressure sensors 5, 6 having the large diameter into the insertion hole 2a having the diameter that is smaller than those of the pressure sensors 5, 6, air maybe supplied into the insertion hole 2a from a first end thereof and at the same time, the pressure sensors 5, 6 may be inserted from a second end.

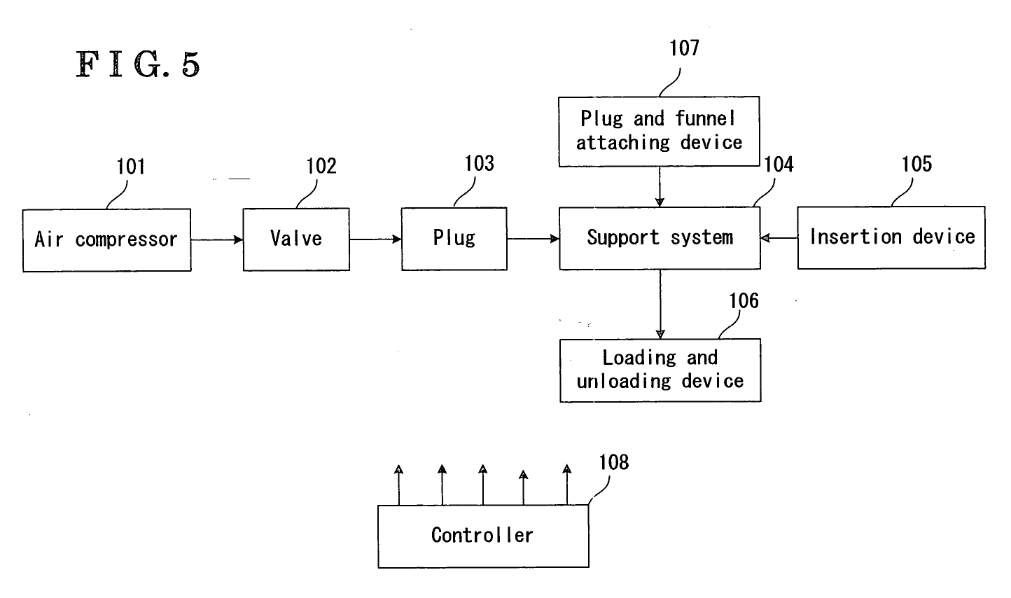

Here, an insertion apparatus for efficiently inserting the pressure sensors 5, 6 into the insertion hole 2a provided on the protector 2 and the apparatus's operation are described with reference to FIGS. 5 to 8. The insertion apparatus is configured by an air compressor 101 (serving as a fluid supply device), a valve 102, a plug 103, a support system 104, an insertion device 105, a loading and unloading device 106, a plug and funnel attaching device 107 and a controller 108.

The air compressor 101 generates pressurized air by compressing the air. The air compressor 101 may be replaced by a pressurized air (gas) cylinder or the like.

The valve 102 is connected to the air compressor 101 via a pipe and controls a flow of the pressurized air from the air compressor 101.

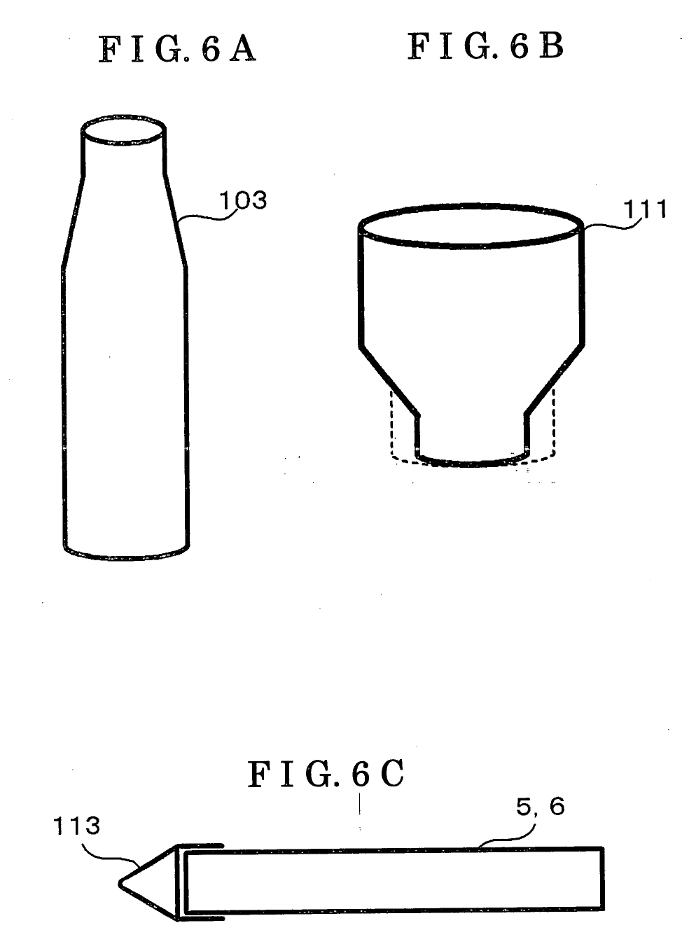

The plug 103 has a tapered configuration shown in FIG. 6A, and one end thereof is connected to a pipe which is connected to the valve 102 and the other end thereof is inserted into the first end of the insertion hole 2a provided on the protector 2.

The support system 104 fixes and supports the protector 2. The insertion device 105 inserts the pressure sensor 5, from the second end, into the insertion hole 2a of the protector 2 fixed and supported by the support system 104.

The loading and unloading device 106 loads the unprocessed protector 2 on the support system 104 and unloads the processed protector 2 including the pressure sensor 5 inserted therein from the support system 104.

The plug and funnel attaching device 107 attaches a funnel 111 shown in FIG. 6B to the second end of the insertion hole 2a provided on the protector 2 supported by the support system 104. The tunnel 111 includes a function to enlarge and reduce a diameter of an end portion of the insertion hole 2a under a control of the plug and funnel attaching device 107.

The controller 108 includes a processor, a program memory and a work memory, and controls an operation of the entire insertion apparatus.

The above described insertion apparatus is installed in, for example, a working environment at room temperature and normal pressure.

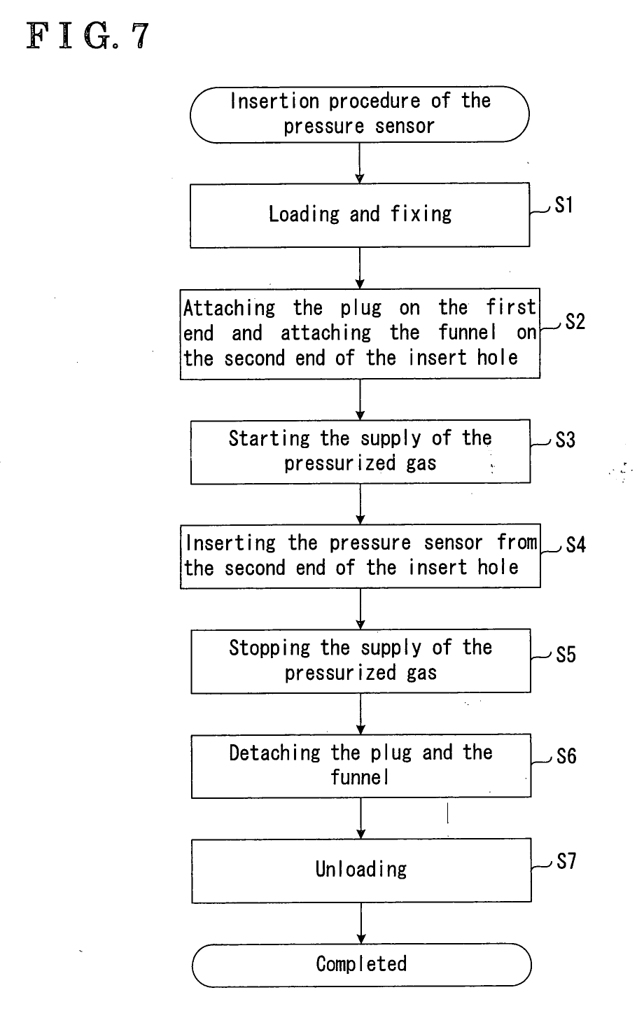

Next, an insertion procedure taken by the insertion apparatus having the above described configuration will be described with reference to a flow chart of FIG. 7. The controller 108 controls the air compressor 101, the valve 102, the plug 103, the support system 104, the insertion device 105, the loading and unloading device 106, the plug and the funnel attaching device 107 to complete the insertion procedure shown in FIG. 7.

First, in Step S1, the controller 108 controls the loading and unloading device 106 so that the unprocessed protector 2 can be loaded on the support system 104, and then fixed and supported thereby.

Next, in Step S2, the controller 108 controls the plug and funnel attaching device 107 so that the plug 103 is attached to the first end of the insertion hole 2a provided on the protector 2 that is fixed and supported by the support system 104 and so that the funnel 111 is attached to the second end thereof as shown in FIG. 8. Then, a diameter of an end of the funnel 111 is enlarged under the control of the controller 108 to allow the pressure sensors 5, 6 to pass therethrough.

Next, in Step S3, the controller 108 allows the valve 102 to open in order to start supplying the pressurized air (gas) from the air compressor 101 into the insertion hole 2a via the plug 103.

Then, in Step 4, as shown in FIG. 8, the controller 108 controls the insertion device 105 so that the pressure sensor 5 is inserted and gradually forced into the insertion hole 2a from the second end via the funnel 111. At this time, the pressure sensor 5 itself serves as a resistance to the flow of the pressurized air supplied by the air compressor 101 to spread the flow of the pressurized air in a direction perpendicular to an axis of the insertion hole 2a, which expands the insertion hole 2a. As a result, the pressure sensor 5 is inserted into the insertion hole 2a smoothly without using lubricants.

After the pressure sensor 5 is inserted into the insertion hole 2a, the controller 108 allows the valve 102 to close in order to stop the supply of the pressurized air (gas) from the air compressor 101 in Step S5.

Then, in Step S6, the controller 108 controls the plug and funnel attaching device 107 so that the plug 103 is detached from the protector 2 fixed and supported by the support system 104 and thereafter the funnel 111 is detached from the protector 2 after the diameter of the end of the funnel 111 is reduced.

In Step 7, the controller 108 controls the loading and unloading device 106 to have the processed protector 2 unloaded from the support system 104.

Up to here, one procedure of inserting the pressure sensor 5 into the protector 2 has been described. The controller 108 starts another sequence of the insertion of the pressure sensor 5 into another protector 2.

As shown in FIG. 6C, an adjusting member for adjusting the flow of the pressurized air, for example, a cone 113 may be attached to an end of the pressure sensor 5 so that the pressure sensor 5 is inserted into the insertion hole 2a while controlling an air turbulence of the pressurized air.

The pressurized air (gas) supplied by the compressor 101 or by the air (gas) cylinder is not limited to the air and may be other kinds of gasses, for example, nitrogen gas. Alternatively, liquid may be applied to and any appropriate types of fluid may be used.

In a case where the protector 2 is made of a foamed material, for example, the foam rubber, the gas supplied by the compressor 101 may leak through fine holes formed on the foamed material, thereby reducing an efficiency of the insertion operation. In such a case, a coating material may be applied to an inner or outer surface of the insertion hole 2a provided on the protector 2 to prevent the gas from leaking.

With the above mentioned configuration of the insertion apparatus, the pressure sensor 5 is inserted into the insertion hole 2a provided on the protector 2 without difficulty under the working environment at room temperature and normal pressure with a high operation efficiency.

As shown in FIG. 2, the pressure sensors 5, 6 are connected to signal transfer lines 7, 7′ by means of connectors 8, 8′. The signal transfer lines 7, 7′ are connected to the entrapment detecting circuit 10 provided in an interior portion of the door panel 3 via a hole 9 provided on the protector 2 of the slide door 1.

The connectors 8, 8′ are arranged integrally with each other in a middle portion of the vertical direction of the slide door 1. The pressure sensor 5 extends from the connector 8 in an upper direction of the figure and the pressure sensor 6 extends from the connector 8′ in a lower direction of the figure. Consequently, the pressure sensors 5, 6 are structured to branch out in the upper and lower direction respectively from the connectors 8, 8′.

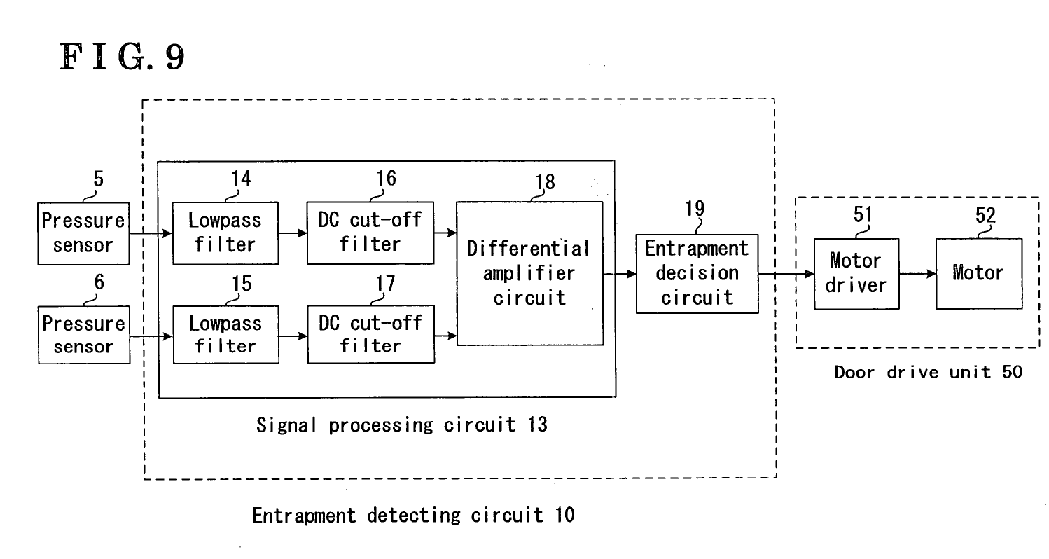

FIG. 9 illustrates a circuit structure of the entrapment detecting apparatus 4. As shown in the figure, the entrapment detecting circuit 10 includes a signal processing circuit 13 and an entrapment decision circuit 19 for determining whether the entrapment has occurred.

The signal processing circuit 13 includes lowpass filters 14, 15 and DC cut-off filters 16, 17 and a differential amplifier circuit 18.

The lowpass filters 14, 15 respectively reduce noises included in high frequency bands of the pressure sensitive output signals output by the corresponding pressure sensors 5, 6. The DC cut-off filters 16, 17 respectively remove direct-current components and low frequency components included in the signals from the corresponding lowpass filters 14, 15, and the DC cut-off filters 16, 17 output the signals to the differential amplifier circuit 18. The two lowpass filters 14, 15 and the two DC cut-off filters 16, 17 respectively have identical output characteristics, and the characteristics of the filters are optimized considering vibration characteristics of a vehicle body.

The respective output signals from the two DC cut-off filters 16, 17 are supplied to the differential amplifier circuit 18. The differential amplifier circuit 18 calculates a difference between the respective signals and supplies a differential signal to the entrapment decision circuit 19.

The entrapment decision circuit 19 stores a predetermined reference value therein for determining the entrapment. When an absolute value of a level of the input voltage signal to the entrapment decision circuit 19 (a level of the output voltage signal from the differential amplifier circuit 18) is equal to or greater than the reference value, the entrapment decision circuit 19 determines that the entrapment has occurred and supplies an entrapment detection signal to a door drive unit 50 driving the slide door 1.

The drive unit 50 includes a motor driver 51 and a motor 52.

The motor driver 51 follows a command given by a control unit and drives the motor 52 so that the slide door 1 is opened or closed. When the entrapment detection signal is supplied by the entrapment decision circuit 19 while the motor 52 is driving, the motor driver 51, regardless of the command from the control unit, stops the motor 52 to stop a movement of the slide door 1, and then reverses the motor 52 to move the slide door 1 in a reverse direction.

According to the entrapment detecting apparatus 4 having the above mentioned structure, the entrapment is detected by means of a simple construction where the diameter of the insertion hole 2a is smaller than those of the pressure sensors 5, 6.

In addition, the pressure sensors 5, 6 are restrained from moving inside the insertion hole 2a because the diameter of the insertion hole 2a is smaller than those of the pressure sensors 5, 6. As a result, even when the protector 2 is vibrated, misdetection of the pressure sensors 5, 6 due to the vibration is less likely to occur.

Because the diameter of the insertion hole 2a is set to be smaller than those of the pressure sensors 5, 6, the protector 2 is fixed firmly inside the insertion hole 2a. This restrains the pressure sensors 5, 6 from being moved by the external vibration. As a result, the voltage generated by the vibration noises is reduced, and thus the misdetection of the pressure sensors 5, 6 is reduced.

Further, since the protector 2 has an appropriate elasticity and ratio of the length of each portion, when the object comes in contact with the protector 2, the end portion of the protector 2 is strained (deformed) first, then the pressure is applied to the sensors 5, 6. After that, the entire protector 2 is gradually deformed, thereby keeping the object free from the intense pressure for the certain period of time, during which the sliding movement of the slide door 1 is stopped or reversed.

The embodiment is not limited to the above mentioned example and various modifications and applications are available. Other possible embodiments will be described hereunder.

In the above mentioned embodiment, the entrapment detecting apparatus 4 (the protector 2 and the pressure sensors 5, 6) is provided on the side of the slide door 1, which is opposed to the door frame 11, so that the entrapment detecting apparatus 4 extends through an entire length of the side of the slide door 1. The entrapment detecting apparatus 4, however, may be provided on a portion or plural portions of the side of the slide door 1.

The above mentioned embodiment is described in the context that the entrapment detecting apparatus 4 is provided on the slide door 1, however, the entrapment detecting apparatus 4 may be provided, for example, on the door frame 11, at a portion opposed to the slide door 1. Also in this case, the entrapment is detected by means of the simple construction.

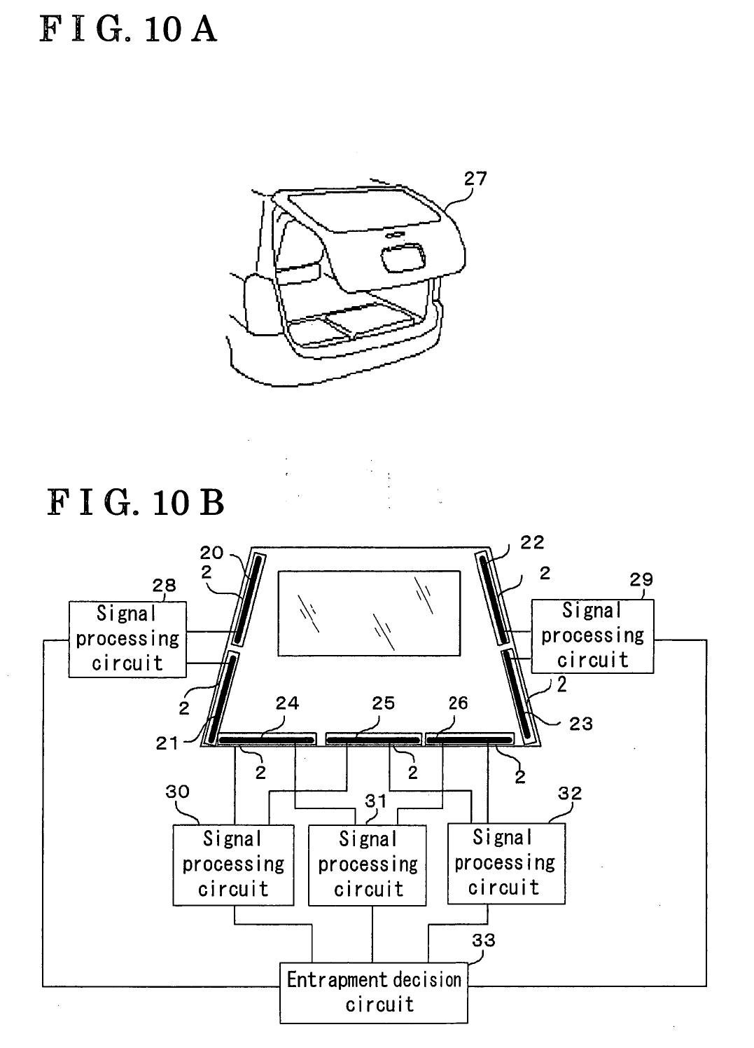

The above mentioned embodiment is described in the context that the entrapment detecting apparatus 4 is applied to the slide door 1 of the vehicle, however, the embodiment is not limited to the example. The entrapment detecting apparatus 4 may be used for other types of doors, for example, a hatchback door (serving as the moving member) of a vehicle. FIG. 10A shows a hatchback door 27 of a vehicle.

When the hatchback door 27 of FIG. 10A is seen from an inside of the vehicle, the protectors 2 with pressure sensors inserted therein are arranged, for example, as shown in FIG. 10B. In this example, plural, for example, two protectors 2 each having a pressure sensor (pressure sensors 20 to 23), are provided on left and right sides of the hatchback door 27 respectively, and plural, for example, three protectors 2 each having a pressure sensor (pressure sensors 24 to 26) are provided on a bottom side of the hatchback door 27. In this example, plural, for example, three signal processing circuits 28 to 32 are provided. The signal processing circuit 28 corresponds to a pair of the pressure sensors 20, 21, the signal processing circuit 29 corresponds to a pair of pressure sensors 22, 23, the signal processing circuit 30 corresponds to a pair of the pressure sensors 24, 25, the signal processing circuit 31 corresponds to a pair of the pressure sensors 24, 26 and the signal processing circuit 32 corresponds to the pressure sensors 25, 26. The differential signals from the circuits 28 to 30 are supplied to an entrapment decision circuit 33.

In the above embodiment, the slide door 1 and the hatchback door 27 of the vehicle are described as the opening and closing portions, however the embodiment may be applied to an electric sunroof or a power window adapted to a vehicle. Further, the embodiment is not limited to an application to a vehicle and may be applied to an automatic door of an elevator, a train, an airplane or a building, or a shutter of a garage, of a shop or the like. The present invention may be applied to any cases where an entrapment of an object in an opening and closing portion may occur. In case of elevator doors where the opening and closing portion is constituted by two moving members facing each other, the embodiment is applied to by considering one of the moving members as the moving member and the other moving member as the paired member.

The two pressure sensors 5, 6 are arranged as a pair of pressure sensors in the above embodiment, however, the two pressure sensors 5, 6 may be replaced by a bar-like pressure sensor (for example, including two stripe-like cables). In this case, the circuit structure shown in FIG. 9 is constructed so that a stop signal or a reverse operation signal is output when the absolute value of the level of the output voltage signal from the pressure sensor (a sensed pressure) exceeds the reference level (a threshold value), after noise components are removed therefrom in the lowpass filter and in the DC cut-off filter.

The material of the protector 2 is preferably made of foam rubber but may not be limited to the foam rubber and may be, for example, a foam silicon rubber, a urethane or other desired elastic material that achieve similar function as that of the foam rubber.

The protector is made of, for example, foam rubber for holding the pressure sensor by elasticity of the foam rubber.

Further, according to the entrapment detecting apparatus 4 described in the aforementioned embodiment, a foaming density of the foam rubber is approximately 0.1 grams to 1 gram per cubic millimeter.

Furthermore, according to the entrapment detecting apparatus 4 described in the aforementioned embodiment, the pressure sensor 5, 6 is, for example, the piezoelectric sensor.

Furthermore, according to the entrapment detecting apparatus 4 described in the aforementioned embodiment, the insertion hole 2a extends along the portion of one of the slide door 1 and the door frame 11 for being opposed to the other of the slide door 1 and the door frame 11, and the pressure sensor 5, 6 has a cable-like outer profile.

Furthermore, according to the entrapment detecting apparatus 4 described in the aforementioned embodiment, the slide door 1 and the door frame 11 serve as the moving member adapted to the vehicle 12 and the frame forming the opening 15 covered or uncovered by the slide door 1 adapted to the vehicle 12, respectively.

Furthermore, according to the entrapment detecting apparatus 4 described in the aforementioned embodiment, the hatchback door 27 and the door frame 11 serve as the moving member adapted to the vehicle 12 and the frame forming the opening 15 covered or uncovered by the hatchback door 27 adapted to the vehicle 12, respectively.

According to the insertion apparatus described in the embodiment, the pressure sensor 5, 6 is inserted into the insertion hole 2a by the insertion device 105 while the insertion hole 2a is expanded by a fluid pressure caused by blocking the flow of the pressurized air supplied from the first end of the insertion hole 2a toward the second end thereof with the pressure sensor 5, 6 inserted from the second end of the insertion hole.

Further, according to the insertion apparatus described in the embodiment, the fluid is air.

Furthermore, according to the insertion apparatus described in the embodiment, the fluid is a nitrogen gas.

Furthermore, according to the insertion apparatus described in the embodiment, the fluid is a liquid.

According to a method for inserting the pressure sensor 5, 6 described in the aforementioned embodiment, the protector 2 is made of foam rubber.

Furthermore, according to the method for inserting the pressure sensor 5, 6 described in the aforementioned embodiment, a foaming density of the foam rubber is approximately 0.1 grams to 1 gram per cubic millimeter.

Furthermore, according to the method for inserting the pressure sensor 5, 6 described in the aforementioned embodiment, for example, a piezoelectric sensor.

Furthermore, according to the method for inserting the pressure sensor 5, 6 described in the aforementioned embodiment, the fluid is air.

Furthermore, according to the method for inserting the pressure sensor 5, 6 described in the aforementioned embodiment, the fluid is a nitrogen gas.

Furthermore, according to the method for inserting the pressure sensor 5, 6 described in the aforementioned embodiment, the fluid is a liquid.

According to the embodiment, the entrapment is detected with the simple construction. Also, the pressure sensor 5, 6 is inserted into the protector 2 without difficulty.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An entrapment detecting apparatus for detecting an entrapment of an object between a moving member and its paired member, the entrapment detecting apparatus comprising:
a pressure sensor serving for detecting the entrapment; and
a protector provided at a portion of one of the moving member and the paired member for being opposed to the other of the moving member and the paired member,
the protector being formed of an elastic material,
the protector being provided therein with an insertion hole in which the pressure sensor is held by elasticity of the elastic member, the insertion hole having a diameter equal to or smaller than that of the pressure sensor, the holding of the pressure sensor in the insertion hole being established in such a manner that the insertion hole is expanded at room temperature to receive the pressure sensor and is restored upon completion of the reception of the pressure sensor.

2. The entrapment detecting apparatus according to claim 1, wherein the protector is made of foam rubber for holding the pressure sensor by elasticity of the foam rubber.

3. The entrapment detecting apparatus according to claim 2, wherein a foaming density of the foam rubber is approximately 0.1 grams to 1 gram per cubic millimeter.

4. The entrapment detecting apparatus according to claim 1, wherein the pressure sensor is a piezoelectric sensor.

5. The entrapment detecting apparatus according to claim 1, wherein the insertion hole extends along the portion and the pressure sensor has a cable-like outer profile.

6. The entrapment detecting apparatus according to claim 1, wherein
the moving member and the paired member are a slide door adapted to a vehicle and a frame forming an opening covered or uncovered by the slide door adapted to the vehicle, respectively.

7. The entrapment detecting apparatus according to claim 1, wherein
the moving member and the paired member are a hatchback door adapted to a vehicle and a frame forming an opening covered or uncovered by the hatchback door adapted to the vehicle, respectively.

8. An insertion apparatus for inserting a bar-like pressure sensor into a protector formed of an elastic material and provided with an insertion hole for inserting the pressure sensor, comprising:
a fluid supply device for supplying fluid from a first end of the insertion hole; and
an insertion device for inserting the pressure sensor from a second end of the insertion hole.

9. The insertion apparatus according to claim 8, wherein the pressure sensor is inserted into the insertion hole by the insertion device and wherein the insertion hole is expanded by a fluid pressure caused by blocking a flow of the fluid supplied from the first end of the insertion hole toward the second end thereof with the pressure sensor inserted from the second end of the insertion hole.

10. The insertion apparatus according to claim 8, wherein the fluid is air.

11. The insertion apparatus according to claim 8, wherein the fluid is a nitrogen gas.

12. The insertion apparatus according to claim 8, wherein the fluid is a liquid.

13. A method for inserting a pressure sensor into a protector constituting an entrapment detecting apparatus, wherein:
the protector is formed of an elastic material and provided with an insertion hole for inserting a bar-like pressure sensor;
a diameter of the insertion hole is equal to or smaller than that of the bar-like pressure sensor; and
the pressure sensor is inserted into the insertion hole while fluid is supplied from a first end of the insertion hole toward the second end thereof to expand the insertion hole by a fluid pressure caused by blocking a flow of the fluid with the pressure sensor.

14. The method for inserting the pressure sensor according to claim 13, wherein the protector is made of foam rubber.

15. The method for inserting the pressure sensor according to claim 13, wherein a foaming density of the foam rubber is approximately 0.1 grams to 1 gram per cubic millimeter.

16. The method for inserting the pressure sensor according to claim 13, wherein the pressure sensor is a piezoelectric sensor.

17. The method for inserting the pressure sensor according to claim 13, wherein the fluid is air.

18. The method for inserting the pressure sensor according to claim 13, wherein the fluid is a nitrogen gas.

19. The method for inserting the pressure sensor according to claim 13, wherein the fluid is a liquid.
